(19) United States
(12) Patent Application Publication
(10) Pub. No.: US 2025/0238815 A1
(43) Pub. Date: Jul. 24, 2025

(54) METHOD AND SYSTEM FOR ELECTRONIC FORECASTING OF CARBON INTENSITY FOR PRODUCT, PROCESS, OR SERVICE LEVERAGING LIFE CYCLE ANALYSIS (LCA)

(71) Applicant: P6Technologies, Inc., Spicewood, TX (US)

(72) Inventor: Joseph G. Berti, Spicewood, TX (US)

(21) Appl. No.: 19/032,588

(22) Filed: Jan. 21, 2025

Related U.S. Application Data
(60) Provisional application No. 63/623,865, filed on Jan. 23, 2024.

(51) Int. Cl. G06Q 30/018; G06Q 10/04

(52) U.S. Cl. CPC G06Q 30/018; G06Q 10/04

(57) ABSTRACT

The present invention embodiments provide a forecasting system that derives carbon intensity, emissions, and environmental impact forecasts from a life cycle assessment (LCA). The forecasting system offers an intuitive, user-friendly interface that simplifies the complexity of forecasting methodologies, making generating forecasts of carbon intensity, emissions, and environmental impacts accessible to a broader audience. It incorporates advanced algorithms and real-time data integration, ensuring accurate and up-to-date forecasts. Additionally, the forecasting system is designed with a modular architecture and is highly configurable, allowing seamless integration with various industries and accommodating diverse products and processes.

### CROSS-REFERENCE TO RELATED APPLICATIONS

This application claims priority to U.S. Provisional Patent Application Ser. No. 63/623,865, entitled “Method and System for Electronic Forecasting of Carbon Intensity for Product, Process, or Service Leveraging Life Cycle Analysis (LCA)” and filed on Jan. 23, 2024, the disclosure of which is incorporated herein by reference in its entirety.

### FIELD OF THE INVENTION

The present invention embodiments relate to the field of environmental sustainability and forecasting. More specifically, a present invention embodiment pertains to an electronic system for producing forecasts of carbon intensity (e.g., an amount of greenhouse gases (e.g., carbon dioxide, etc.) per unit of activity, etc.), emissions, and carbon credits (e.g., tax or other credits, monetary or other value, etc.), for a product, service, or process.

The present invention embodiments further relate to the field of environmental impact assessment and, more specifically, to a forecasting system to generate a forecast based upon the results of a life cycle assessment (LCA), where the life cycle assessment provides the environmental footprint and impact analysis of products or processes including the inputs, energy, outputs, processes, and equipment used to produce a product, service, or process.

### BACKGROUND

Traditional life cycle assessment (LCA) and software tools that measure a company's carbon footprint have been pivotal in assisting businesses and organizations in analyzing the environmental impacts associated with their products, services, or processes.

Traditional forecasting and software tools forecast the production of a company's products, but do not forecast the carbon intensity, emissions, and environmental impacts those products have.

Life cycle assessment and forecasting have not been combined in the manner needed to produce accurate forecasts for carbon intensity, emissions, and environmental impacts of products being produced by companies.

Existing software tools suffer from limitations, including:
Complexity: Conventional LCA software tools are based upon historical data and do not provide forecasts of carbon intensity, emissions, and carbon credits for a product, process, or service.
Limited Scope: Existing software tools focus on performing impact analysis and do not use the data or results of the life cycle assessment to forecast the carbon intensity and emissions.
Data Accuracy: The accuracy of traditional forecasting tools do not generate their forecasts on accurate results from a life cycle assessment. Existing software tools sometimes lack access to updated or precise data sources, leading to less accurate forecasts of carbon intensity and emissions;
User Interface: User interfaces of existing tools can be unintuitive and challenging for non-experts, hampering the efficient use of these tools for decision-making. Forecasts are resource-intensive, completed typically from spreadsheets versus software tools.
Incomplete: Existing life cycle assessment systems do not produce a forecast for carbon intensity based upon a life cycle assessment.
Use of secondary source data: Existing software tools require the use of databases from secondary sources for emissions factors. These emissions factors are not directly tied to the source facility that produces a product or provides a service and, therefore, are not accurate, and hence, will generate inaccurate forecasts.
Inability to generate scenarios: Existing software tools do not allow for forecasting scenarios to be generated where the inputs, processes, equipment, and outputs can be easily compared.
Electronic data exchange: Existing software tools, including spreadsheets, do not allow a company to share carbon intensity and emissions forecasts electronically across the supply chain in a manner that allows the recipient of that information to receive forecast updates that are made to a product, process or service, typically, as the result of changes made to the production facility, process, or service. This results in forecasts being static and not communicated in a real-time manner, therefore, being inaccurate. The existing systems utilize complex database exports, so the data is not easily consumed or utilized across the supply chain.

### BRIEF SUMMARY OF EMBODIMENTS OF THE INVENTION

The present invention embodiments provide a carbon intensity, carbon credit, and emissions forecasting system for a product, process, or service that addresses the above and other limitations of existing approaches. The system offers an intuitive, user-friendly interface that simplifies the complexity of forecasting for carbon intensity, emissions, and carbon credits making product, process, or service forecasting accessible to a broader audience. It incorporates advanced forecasting algorithms and real-time data integration, ensuring accurate and up-to-date forecasts. Additionally, the forecasting system is designed with a modular architecture and is highly configurable, allowing seamless integration with various industries and accommodating diverse products and processes.

Present invention embodiments provide several advantages, including:
User-Friendly Interface: The forecasting system provides an intuitive interface, enabling users with varying levels of expertise to perform comprehensive forecasts effortlessly. The forecasting system leverages historical production data, life cycle assessment data and results, and existing life cycle assessment impact methods and models, thereby making it possible to produce a forecast;
Scalability and Flexibility: The modular design leveraging configurable LCA templates allows the forecasting system to adapt to different industries and accommodate a wide range of products and processes, making it versatile and scalable;
Primary source data: The forecasting system provides the ability to reach out to a supplier to ask them to perform a complete LCA using a template, allowing the supplier to complete the LCA faster and eliminating the need for secondary databases and resulting in a more accurate assessment of the life cycle of a product or service;
Real-time Data Updates: The forecasting system incorporates real-time data updates to forecast where data from product, process, or service outputs allow the system to generate a forecast on the most current and accurate data available.
Decision Support: The forecasting system offers valuable insights and suggestions for sustainable practices, reducing carbon intensity and emissions, empowering businesses to make informed decisions for reducing their environmental footprint for products, processes, or services leveraging data from forecasts and scenarios generated by forecasts;
Cloud-Based Collaboration: The forecasting system preferably operates on a cloud-based platform, facilitating collaborative efforts among stakeholders, regardless of their geographical locations, enhancing efficiency and productivity. Stakeholders include engineering, operations, raw material suppliers, equipment manufacturers, compliance and customers of the product, process or service;
Efficient Data Structures: The forecasting system summarizes and stores data in a manner that allows large amounts of information to be displayed on a computerized screen. This is accomplished by performing complex calculations on the data prior to it being stored so that complex calculations have already been made prior to rendering the data on a computerized screen;
Real-Time: The forecasting system updates forecasts in real-time as data or life cycle assessments are updated, allowing for all participants in the supply chain to immediately benefit from improvements made to product processes, energy, inputs, or outputs; and
Frequency: The forecasting system provides both historical actuals and forecasted carbon intensity, emissions, and carbon credits generated (or consumed). This moves a company from a historical view of a carbon intensity and emissions, often updated every 1-2 years, to a daily, weekly, or monthly forecast on how their facilities are trending.

Accordingly, the present invention embodiments provide a significant advancement in the field, offering a user-friendly, accurate, and versatile technique for assessing the environmental impact of products and processes. The features and functionalities of present invention embodiments revolutionize the way to approach sustainability, aligning environmental responsibility with economic success.

### BRIEF DESCRIPTION OF THE DRAWINGS

Generally, like reference numerals in the various figures are utilized to designate like components.

FIG. 1 is a diagrammatic illustration of a system architecture including system components, such as the user interface, model builder and engine, process builder, workflow engine, application programming interface, database, and corresponding software according to an embodiment of the present invention.

FIG. 2 illustrates a process flow diagram showing the operations involved in forecasting according to an embodiment of the present invention.

FIG. 3 is a schematic illustration of an example graphical user interface representing a comparison of forecasted carbon intensity to actual carbon intensity according to an embodiment of the present invention.

FIG. 4 is a schematic illustration of an example graphical user interface representing forecasted carbon intensity in a table format according to an embodiment of the present invention.

FIG. 5 is a schematic illustration of an example graphical user interface representing the historical or forecasted carbon intensity in both a graphical and table format according to an embodiment of the present invention.

FIG. 6 is a schematic illustration of an example graphical user interface representing the historical or forecasted carbon intensity of a product produced by a facility based on the inputs in both a graphical and table format according to an embodiment of the present invention.

FIG. 7 is a schematic illustration of an example graphical user interface representing the historical and forecasted tax credits and/or carbon credits displayed in both a graphical and table format according to an embodiment of the present invention.

FIG. 8 is a schematic illustration of an example graphical user interface for configuring settings for a forecast according to an embodiment of the present invention.

FIG. 9 is a block diagram of an example computing device according to an embodiment of the present invention.

### DETAILED DESCRIPTION OF EXAMPLE EMBODIMENTS

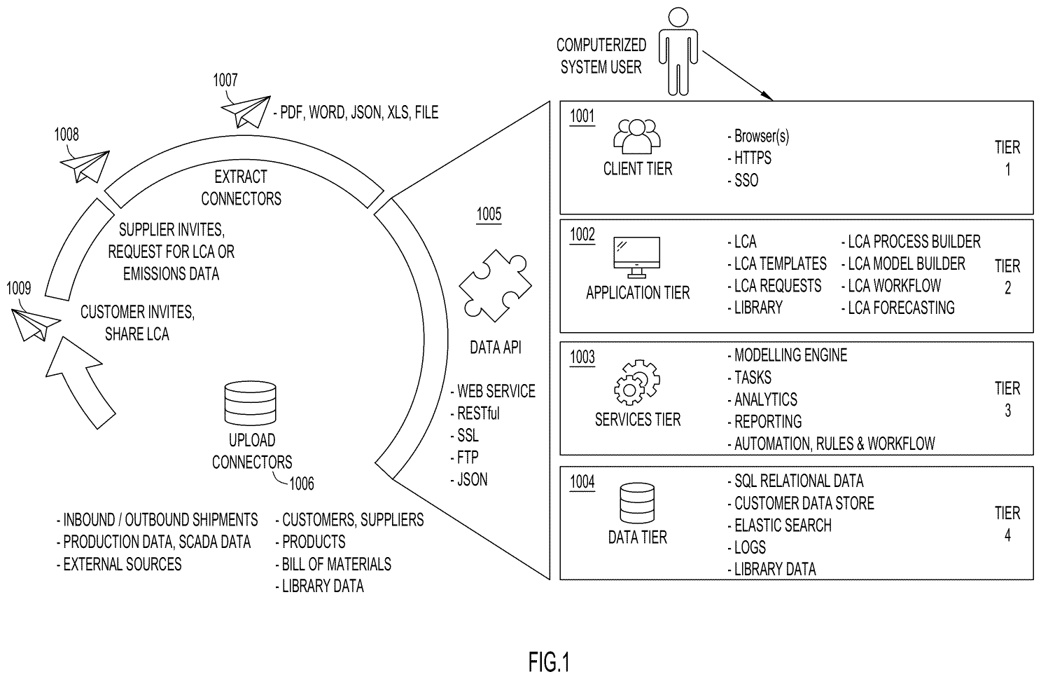

An example system architecture according to an embodiment of the present invention is illustrated in FIG. 1. By way of example, the electronic forecasting system is accessed via a browser 1001 by a system user. The electronic system includes a software application 1002 that provides the functionality via a computerized user interface. The software also includes computerized services 1003 that perform calculations, move data, and automate the completion of work. This includes a modelling engine to forecast carbon intensity, an analytics engine that summarizes data for complex reporting, a task engine that is used to complete specific tasks, an automation engine that is used to automate work, and a rules and workflow engine that is used to perform complex rules and manage workflow within the application.

The electronic forecasting system also includes a data tier 1004 that is used for storing and retrieving data in relational databases, column stores, elastic search, and graph databases. The data tier also includes customer data stores where data can be uploaded from a customer system into the electronic forecasting system.

The forecasting system also includes application programming interfaces 1005 to allow data to be imported and exported from the system using a web service (e.g., RESTFUL service, SSL, FTP, JSON, etc.).

The electronic forecasting system includes connectors 1006 to external software tools to case the import and export of data from the electronic forecasting system. Data such as, but not limited to, shipments, production data (inventory), data from SCADA systems (such as temperature or moisture readings), customer data, supplier data, bill of material data, and library data which includes emissions factor data from government, open source, and third-party licensed data. The electronic forecasting system may also include extract connectors 1007 to produce PDF, Binary, WORD, JSON, XLS, Flat File, and XML exports to external users and computerized systems.

The electronic forecasting system can electronically invite suppliers 1008 to perform life cycle assessments or provide emissions factor data, and can electronically invite customers 1009 to share electronic life cycle assessments with them.

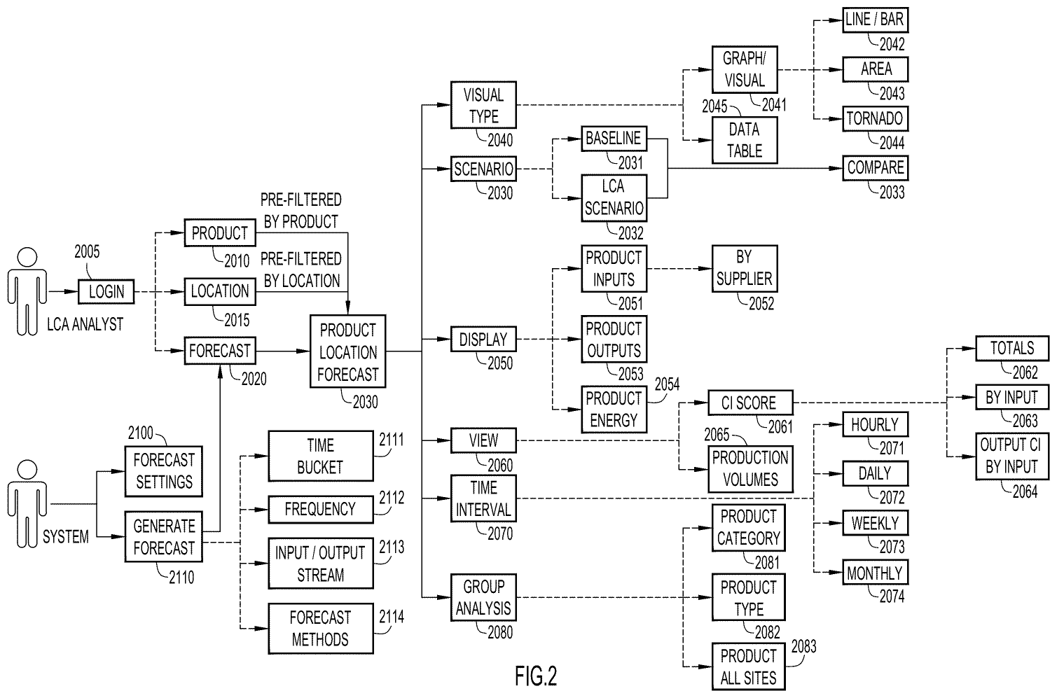

A flow diagram for performing carbon intensity forecasts according to an embodiment of the present invention is illustrated in FIG. 2. By way of example, a user (e.g., life cycle assessment (LCA) or other analyst, etc.) logs into the forecasting system running on the cloud at operation 2005 to provide selections or commands for performing forecasts and/or generating views at operation 2020 as described below. The forecasting system may generate a view of carbon intensity, emissions, and environmental impact forecasts by a product type 2010 for a single location 2015 where it is produced, or for all locations 2015 where the product type is produced. The forecasting system may further generate at operation 2025 a view of carbon intensity, emissions, and environmental impact forecasts by a location 2010, for all the products 2010 at a location 2015, or for a specific product 2010 at a location 2015.

The forecasting system may generate a view 2040 of carbon intensity, emissions, and environmental impact forecasts displayed using a graphical format 2041 including, but not limited to, a line and bar chart 2042 or a combination thereof. The forecasting system may generate a view 2040 of carbon intensity, emissions, and environmental impact forecasts displayed using a graphical format 2041 including, but not limited to, an area chart 2043. The forecasting system may also generate a view 2040 of carbon intensity, emissions, and environmental impact forecasts displayed using a graphical format 2041 including, but not limited to, a tornado chart 2044, specifically used to compare various scenarios of how material or other inputs, outputs, electricity mix or types, processes, or various equipment are operating at a site. In addition, the forecasting system may generate a view 2040 of carbon intensity, emissions, and environmental impact forecasts displayed using a data table 2045.

The forecasting system may generate a view of carbon intensity, emissions, and environmental impact forecasts for scenarios 2030 including a production facility as it is currently operating, referred to as a baseline 2031 of the facility. The forecasting system may generate a view of carbon intensity, emissions, and environmental impact forecasts for a product leveraging a life cycle assessment (LCA) 2032 as the basis for the forecast. The forecasting system may also generate a view of carbon intensity, emissions, and environmental impact forecasts for a product with the ability to compare baseline forecasts 2031 to scenarios 2032 at operation 2033, as defined by a life cycle assessment (LCA), including the ability to compare multiple different scenarios (relative to the LCA) and/or the baseline altogether at once. For example, factors of the LCA affecting the forecast (e.g., carbon intensity, emissions, carbon credits, etc.) may be adjusted (to provide modified LCAs) to provide the different scenarios. The factors may include material inputs, electricity mix, processes, equipment, and/or outputs.

The forecasting system may generate an LCA, or an LCA may be generated by another system or manually, and provided to the forecasting system. By way of example, an LCA may be generated, viewed, shared, and/or include information as described in U.S. Provisional Patent Application Ser. No. 63/595,040 (entitled “Method and System for Electronic Life Cycle Assessment (LCA) for Supply Chain Management Leveraging Templates” and filed on Nov. 1, 2023) and/or U.S. patent application Ser. No. 18/931, 316 (entitled “Method and System for Electronic Life Cycle Assessment (LCA) for Supply Chain Management Leveraging Templates” and filed on Oct. 30, 2024), the disclosures of which are incorporated herein by reference in their entireties.

The forecasting system may generate a view at operation 2050 of carbon intensity, emissions, and environmental impact forecasts. The view may be generated for a product summarized by the inputs or energy a supplier has provided at operation 2051 resulting in the ability to compare suppliers leveraging a forecast and life cycle assessment (LCA) at operation 2052. The forecasting system may generate the view of carbon intensity, emissions, and environmental impact forecasts for a site and products production output, carbon intensity, or the carbon credits generated at operation 2053. The forecasting system may also generate the view of carbon intensity, emissions, and environmental impact forecasts for a site and products energy inputs or outputs at operation 2054.

The forecasting system may generate a view of carbon intensity, emissions, and environmental impact forecasts for a site and products production output along with the potential tax credits or carbon credits generated for a site at operation 2060. The view may be for production volumes at operation 2065. The forecasting system may generate the view with carbon intensity forecast totals 2061 for a site and product over time intervals at operation 2062. The forecasting system may generate the view of carbon intensity, emissions, and environmental impact forecasts for a site and product by various inputs used to produce a product at operation 2063, which thereby affect the carbon intensity of the products by a production facility. The forecasting system may also generate the view of carbon intensity, emissions, and environmental impact forecasts for a site and product by sorting the production output by the inputs used to produce a product at operation 2064.

The forecasting system may generate a view of carbon intensity, emissions, and environmental impact forecasts for a site and product by various time intervals at operation 2070. The time intervals include, but are not limited to, 3, 6, 9, 12, or 24 months into the future in hourly increments at operation 2071, daily increments at operation 2072, weekly increments at operation 2073, or monthly increments at operation 2074.

The forecasting system may generate a view of carbon intensity, emissions, and environmental impact forecasts for a site and product for group analysis at operation 2080. The view may be by product category at operation 2081, allowing for group analysis of forecasts. The forecasting system may generate the view of carbon intensity, emissions, and environmental impact forecasts for a site and product by product type at operation 2082, allowing for group analysis of forecasts. The forecasting system may generate the view of carbon intensity, emissions, and environmental impact forecasts for a product across all sites where it is produced at operation 2083.

By way of further example, a user (e.g., system user, administrator, etc.) logs into the forecasting system running on the cloud to provide forecast settings and selections or commands at operation 2100 for performing forecasts described below. The forecasting system may configure the settings of the forecasts to configure time buckets, frequency of how often the forecast is updated, what input/output streams are considered, and the forecast techniques utilized, sometimes by product category or type.

The forecasting system includes a computerized system process that generates the forecasts automatically at operation 2110 utilizing data from a production facility or from a life cycle assessment (LCA) (or scenario). The computerized system process may generate the carbon intensity, emissions, and environmental impact forecasts automatically into various time buckets at operation 2111 including, but not limited to, hourly, daily, weekly, or monthly. The computerized system process may generate or update the carbon intensity, emissions, and environmental impact forecasts automatically in time intervals at operation 2112, such as hourly, daily, weekly, or monthly. The computerized system process may generate or update the carbon intensity, emissions, and environmental impact forecasts automatically by input or output stream, as defined by the system configuration, at operation 2113, allowing for the forecasts to be segmented. The computerized system process may also generate or update the carbon intensity, emissions, and environmental impact forecasts automatically utilizing various conventional or other forecast techniques or models at operation 2114. The forecast techniques or models may include, but are not limited to, Average, Weighted Average, Moving Average, Single Exponential Smoothing, Double Exponential Smoothing, Same As Last Year, Linear Regression, Winters Multiplicative, Intermittence Smoothing, Crostons, Manual Forecast, and/or Do Not Forecast.

The forecasting system provides rapid generation of the data visualizations (e.g., charts, tables, etc.) for the user interfaces described below. This may be accomplished by storing data in an optimized format by performing complex calculations on data prior to storage and also by storing data in a format where little to no calculations or data manipulation is necessary to display the data. For example, forecasts are pre-calculated and stored in time buckets that allow the screens to render the forecast quickly because it summarizes large amounts of information in the manner in which it is displayed on the screen. Input data is also pre-summarized in hourly, daily, weekly, and monthly time buckets and segmented by configurable input streams which also speeds up forecasting calculations. Furthermore, data obtained from life cycle assessments in the system can be quickly incorporated into a forecast by leveraging a JSON data structure that describes the data in a life cycle assessment in a way that allows it to be quickly used to regenerate a forecast. This optimized data storage and structure enables the forecasting system to accommodate real-time or near real-time forecasting as data changes. The JSON structure includes historical inventory data by input by time bucket, e.g., hourly, daily, weekly, monthly, and maps this data to inputs, outputs, processes, or services. The JSON data structure also maps inventory data to the model used to calculate carbon intensity and provides emissions factors needed to perform calculations. Because the LCA data is in the structured format that describes the inputs, outputs, energy, model, and emissions factors, this allows for the system to generate or recalculate new forecasts quickly.

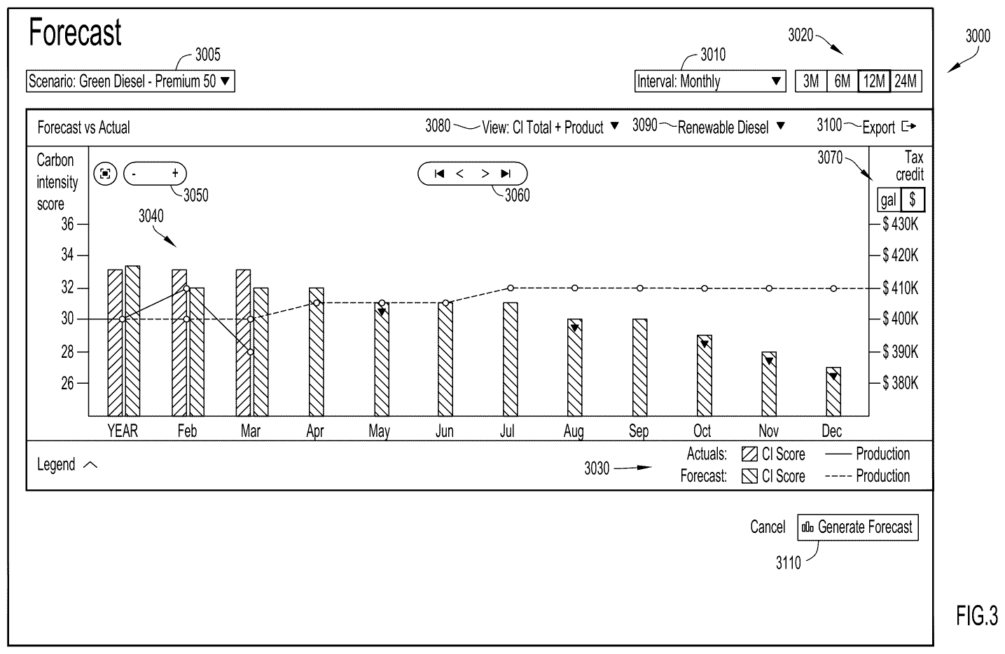

An example user interface 3000 representing a comparison of forecasted carbon intensity to actual carbon intensity according to an embodiment of the present invention is illustrated in FIG. 3. In an example, a forecast 3005 of carbon intensity, emissions, carbon credits, and environmental impacts is generated for an operation. This forecast is referred to as a baseline forecast, and may be generated using data of the operation and the models in substantially the same manner described above. Forecasts can also be generated based upon a model (described above) and outputs of a life cycle assessment (LCA) in substantially the same manner described above. Therefore, a user can choose between the baseline forecast or a forecast based upon an LCA (referred to as a forecast scenario).

In an example, forecasts of carbon intensity, emissions, carbon credits, and environmental impacts may be viewed in monthly, weekly, daily, or hourly increments via an actuator 3010. Forecasts of carbon intensity, emissions, carbon credits, and environmental impacts may be viewed in different future time intervals, such as 3 months, 6 months, 12 months, or 24 months into the future via actuators 3020. A legend 3030 describes the forecast, including the planned versus actual carbon intensity, as compared to the product output of a facility.

In an example, on a bar and/or line graph 3040, the carbon intensity of the output of a production facility may be displayed. The timeframe of the forecast may be zoomed in and out via actuators 3050. A user may scroll right and left through time to view the forecast of carbon intensity, emissions, carbon credits, and environmental impacts via actuators 3060. The production output or carbon credits generated by a facility can be viewed at area 3070 to compare production output with the carbon intensity trend over time. Different views, such as, but not limited to, carbon intensity and production output, may be displayed via actuator 3080 to allow data generated by the forecasting system to be viewed. Forecasts for varying outputs may be displayed for facilities that have more than one output or byproduct produced at the facility via actuator 3090. Generated forecasts may be exported to varying formats via actuator 3100, such as but not limited to Excel, CSV, or PDF. In addition, when edits are made to historical data or the forecast, the forecast can be re-run to dynamically re-forecast based upon updated data via actuator 3110.

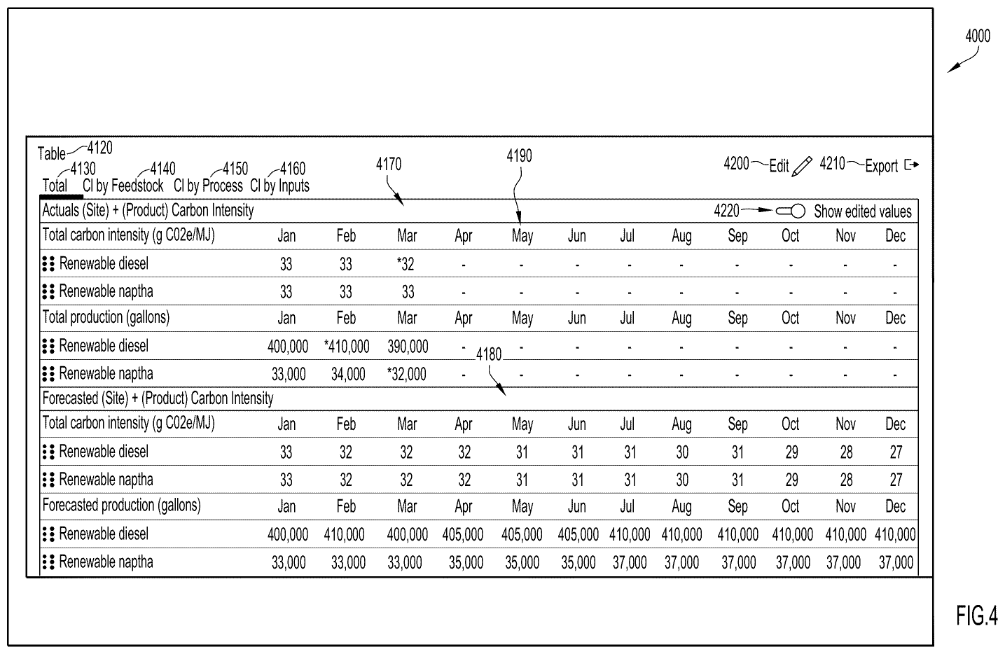

An example user interface 4000 representing forecasted carbon intensity in a table format according to an embodiment of the present invention is illustrated in FIG. 4. In an example, forecast data may be viewed in a table format 4120 that shows inputs, outputs, processes, production history, production forecast, historical carbon intensity of both inputs and outputs, historical emissions, environmental impacts and carbon credits. Forecast totals may be used for enabling a summary of the planned versus actuals to be viewed via actuator 4130. The historical actuals versus the generated forecast of the carbon intensity of each input (feedstock) may be viewed via actuator 4140. The historical actuals versus the generated forecast of the carbon intensity of each process may also be viewed via actuator 4150. In addition, the historical actuals versus the generated forecast of the carbon intensity of the resulting product produced by the facility may be viewed based upon the inputs via actuator 4160.

In an example, historical actuals are displayed for inputs, energy, processes, and outputs in a table format 4170, by month, week, day, or hour. The forecast is also displayed for inputs, energy, processes, and outputs in a table format 4180, by month, week, day, or hour. Data in rows 4190 of the table may be re-ordered via a drag and drop technique to allow data to be more easily compared.

In an example, both historical and forecast data may be edited when the user chooses to do so via actuator 4200. Both historical and forecasted data in a table format may be exported in various formats via actuator 4210 including, but not limited to, Excel, CSV, or PDF. In addition, both historical and forecast data may be edited while the forecast system keeps track of both the original and the edited values via actuator 4220. Therefore, the edited values can be displayed or hidden.

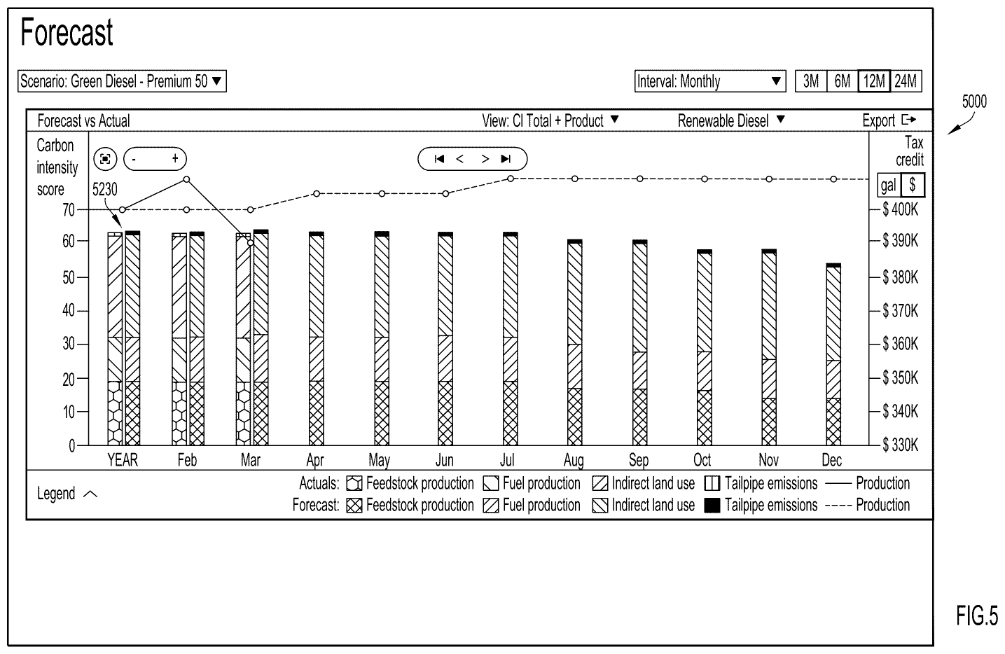

An example user interface 5000 representing the historical or forecasted carbon intensity in both a graphical and table format according to an embodiment of the present invention is illustrated in FIG. 5. In an example, the historical or forecasted carbon intensity may be displayed in both a graphical and table format 5230 by time integral, broken down by life cycle stage (or process). This provides visibility as to where in the process the carbon intensity is changing.

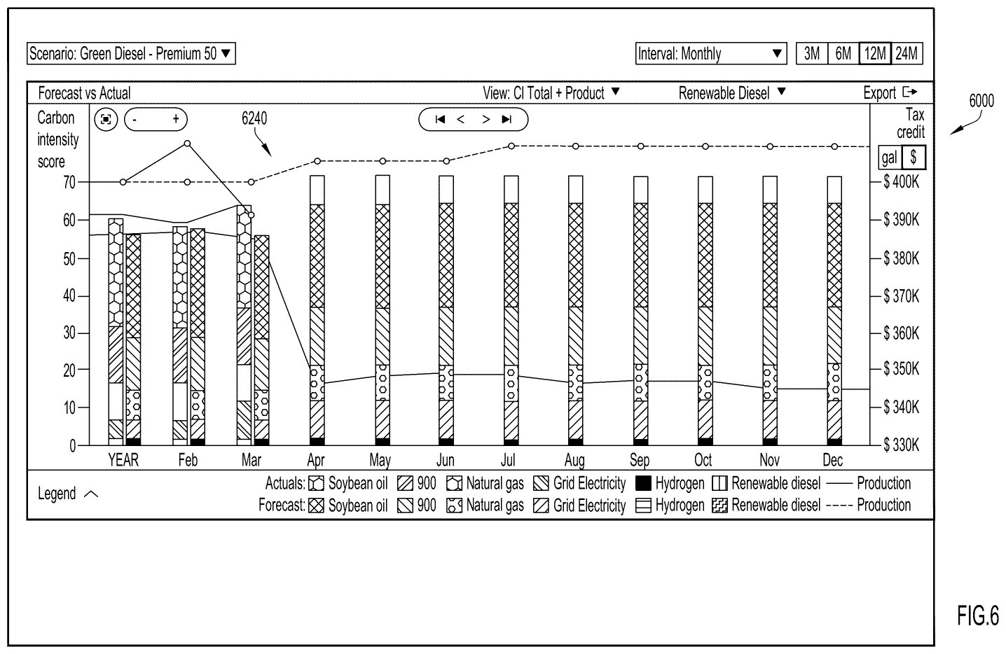

An example user interface 6000 representing the historical or forecasted carbon intensity of a product produced by a facility based on the inputs in both a graphical and table format according to an embodiment of the present invention is illustrated in FIG. 6. In an example, the historical or forecasted carbon intensity of a product produced by a facility based on the inputs may be displayed in both a graphical and table format 6240 by time integral, broken down by life cycle stage (or process). This provides visibility into how various inputs affect the production of a product.

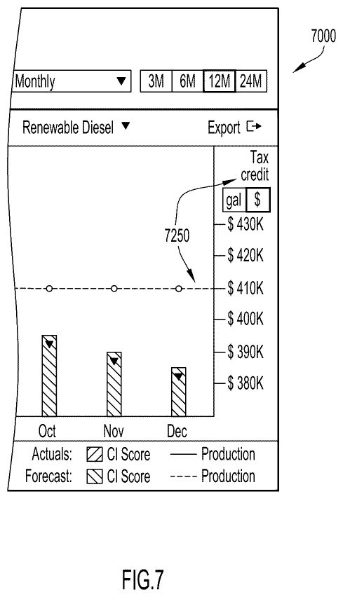

An example user interface 7000 representing the historical and forecasted tax credits and/or carbon credits displayed in both a graphical and table format according to an embodiment of the present invention is illustrated in FIG. 7. In an example, the historical and forecasted tax credits and/or carbon credits may be generated by the forecasting system and displayed in both a graphical and table format 7250.

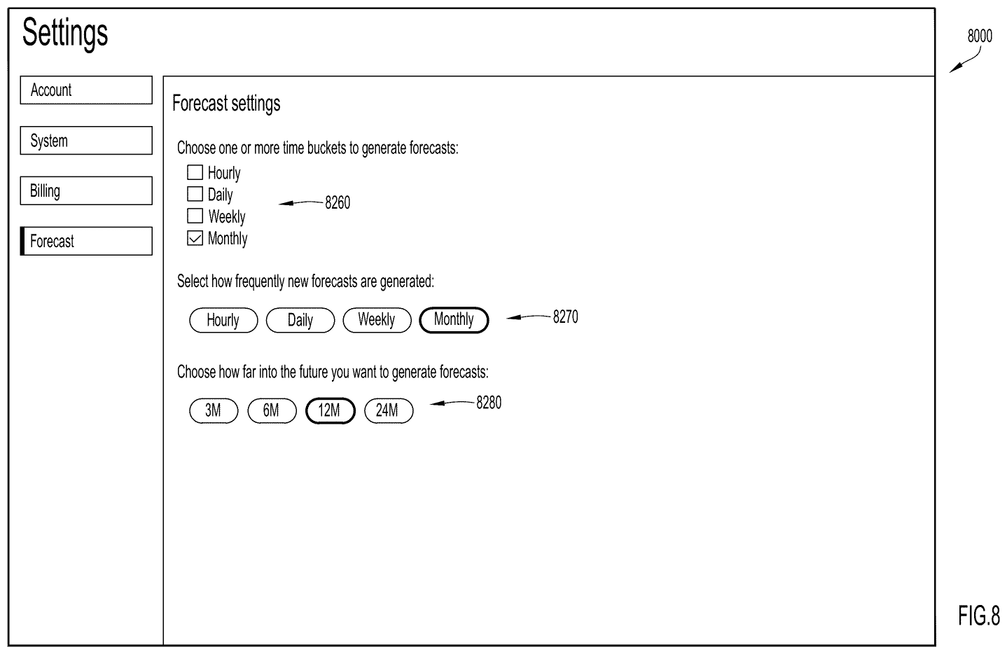

An example user interface 8000 for configuring settings for a forecast according to an embodiment of the present invention is illustrated in FIG. 8. In an example, a user may configure the settings for the forecast, including the time buckets for which forecast data will be totaled via actuators 8260. The time buckets include, but are not limited to, hourly, daily, weekly, and monthly time buckets. The user may also configure settings for the forecast, including the time buckets for which forecast data will be generated (or updated) including, but not limited to, hourly, daily, weekly, and monthly time intervals for updating the forecast via actuators 8270. In addition, the user may configure settings for the forecast including how far into the future forecasts will be generated via actuator 8280. The future time intervals include, but are not limited to, 3-months, 6-months, 12-months, or 24 months into the future.

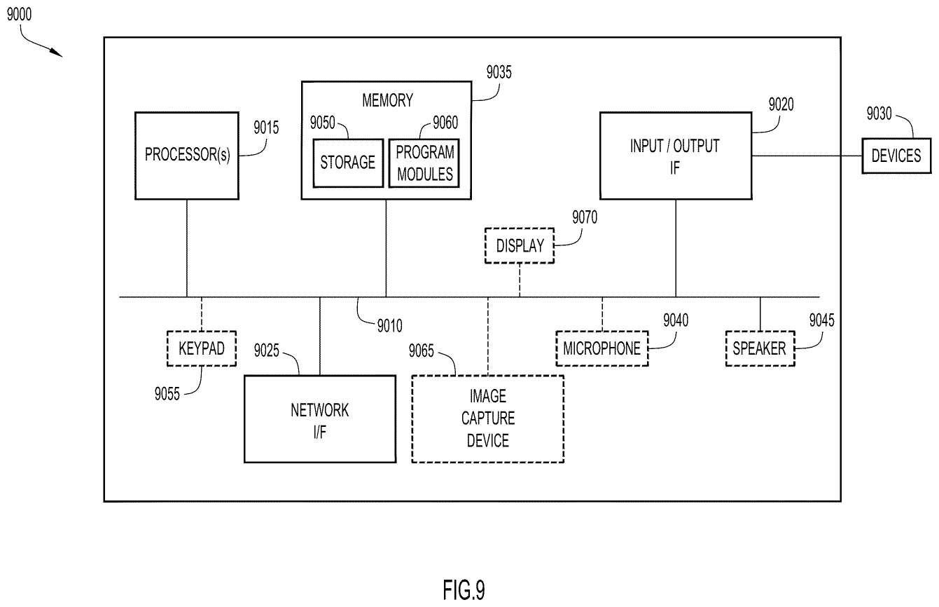

An example of a computing device 9000 (e.g., implementing server systems, client systems, etc.) is illustrated in FIG. 9. The example computing device may perform the functions of present invention embodiments described herein. Computing device 9000 may be implemented by any personal or other type of computer or processing system (e.g., server, desktop, laptop, hand-held device, smartphone or other mobile device, etc.), and may be used for any computing environments (e.g., cloud computing, client-server, hybrid, network computing, mainframe, quantum computer, stand-alone systems, etc.).

Computing device 9000 may include one or more processors 9015 (e.g., computing grid, microprocessor, controller, central processing unit (CPU), etc.), network interface 9025, memory 9035, a bus 9010, and an Input/Output interface 9020. Bus 9010 couples these components for communication, and may be of any type of bus structure, including a memory bus or memory controller, a peripheral bus, and a processor or local bus using any of a variety of conventional or other bus architectures. Memory 9035 is coupled to bus 9010 and typically includes computer readable media including volatile media (e.g., random access memory (RAM), cache memory, etc.), non-volatile media, removable media, and/or non-removable media. For example, memory 9035 may include storage 9050 containing nonremovable, non-volatile magnetic or other media (e.g., a hard drive, virtual drive, etc.). The computing device may further include a magnetic disk drive and/or an optical disk drive (not shown) (e.g., CD-ROM, DVD-ROM or other optical media, etc.) connected to bus 9010 via one or more data interfaces.

Moreover, memory 9035 includes a set of program modules 9060 that are configured to perform functions of present invention embodiments described herein. For example, program modules 9060 may correspond to the system architecture software described above for FIG. 1. The memory may further include an operating system, at least one application and/or other modules, and corresponding data. These may provide an implementation of a networking environment.

Input/Output interface 9020 is coupled to bus 9010 and communicates with one or more peripheral or external devices 9030 (e.g., a keyboard, mouse or other pointing device, a display, sensing devices, etc.), at least one device that enables a user to interact with computing device 9000, and/or any device (e.g., network card, modem, etc.) that enables computing device 9000 to communicate with one or more other computing devices. Computing device 9000 may communicate with one or more networks (e.g., a local area network (LAN), a wide area network (WAN), a public network (e.g., the Internet), etc.) via network interface 9025 coupled to bus 9010.

With respect to certain entities (e.g., client system, etc.), computing device 9000 may further include, or be coupled to, a touch screen or other display 9070, a camera or other image capture device 9065, a microphone or other sound sensing device 9040, a speaker 9045 to convey sound, and/or a keypad or keyboard 9055 to enter information (e.g., alphanumeric information, etc.). These items may be coupled to bus 9010 or Input/Output interface 9020 to transfer data with other elements of computing device 9000.

It will be appreciated that the embodiments described above and illustrated in the drawings represent only a few of the many ways of implementing embodiments for a method and system for electronic forecasting of carbon intensity for product, process, or service leveraging life cycle analysis (LCA). In addition, characteristics or features of embodiments of the present invention may be combined in any fashion to provide additional embodiments of the present invention.

The computing environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., server, desktop, laptop, hand-held devices, smartphones or other mobile devices, etc.), and may include any commercially available operating system and any combination of commercially available and custom software (e.g., communications software; server software; software of present invention embodiments; etc.). These systems may include any types of monitors and input devices (e.g., keyboard, mouse, voice recognition, etc.) to enter and/or view information.

It is to be understood that the software of the present invention embodiments (e.g., program modules 9060, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., program modules 9060, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer useable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., forecasts, results, scenarios, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

Having described preferred embodiments of a new and improved system, method, and computer program product for electronic forecasting of carbon intensity for product, process, or service leveraging life cycle analysis (LCA), it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method comprising:
determining, via at least one processor, a baseline forecast for an item based on operational data for the item, wherein the item includes one of a product, process, and service;
generating, via the at least one processor, a forecast for the item based upon an assessment of the item during a life cycle; and
executing, via the at least one processor, different scenarios relative to the assessment to compare forecasts for the item and different scenarios to the baseline forecast, wherein the baseline forecast and the forecasts for the item and different scenarios indicate carbon intensity, emissions, and carbon credits, and wherein the different scenarios are based upon changes to factors affecting the forecast for the item.

2. The method of claim 1, wherein the factors include one or more from a group of material inputs, electricity mix, processes, equipment, and outputs.

3. The method of claim 1, further comprising:
periodically updating, via the at least one processor, the baseline forecast and the forecasts for the item and different scenarios at a configurable time interval.

4. The method of claim 1, wherein the baseline forecast and the forecasts for the item and different scenarios encompass a configurable future time interval.

5. The method of claim 1, further comprising:
generating, via the at least one processor, a visualization of the forecast for the item against actual values.

6. The method of claim 5, wherein the visualization includes a graph and a data table for the forecast for the item and actual values.

7. The method of claim 1, further comprising:
updating, via the at least one processor, the baseline forecast and the forecasts for the item and different scenarios in real-time as data changes.

8. A system comprising:
one or more memories; and
at least one processor coupled to the one or more memories, and configured to:
determine a baseline forecast for an item based on operational data for the item, wherein the item includes one of a product, process, and service;
generate a forecast for the item based upon an assessment of the item during a life cycle; and
execute different scenarios relative to the assessment to compare forecasts for the item and different scenarios to the baseline forecast, wherein the baseline forecast and the forecasts for the item and different scenarios indicate carbon intensity, emissions, and carbon credits, and wherein the different scenarios are based upon changes to factors affecting the forecast for the item.

9. The system of claim 8, wherein the factors include one or more from a group of material inputs, electricity mix, processes, equipment, and outputs.

10. The system of claim 8, wherein the at least one processor is further configured to:
periodically update the baseline forecast and the forecasts for the item and different scenarios at a configurable time interval.

11. The system of claim 8, wherein the baseline forecast and the forecasts for the item and different scenarios encompass a configurable future time interval.

12. The system of claim 8, wherein the at least one processor is further configured to:
generate a visualization of the forecast for the item against actual values, wherein the visualization includes a graph and a data table for the forecast for the item and actual values.

13. The system of claim 8, wherein the at least one processor is further configured to:
update the baseline forecast and the forecasts for the item and different scenarios in real-time as data changes.

14. A computer program product comprising one or more computer readable media having instructions stored thereon, the instructions executable by at least one processor to cause the at least one processor to:
determine a baseline forecast for an item based on operational data for the item, wherein the item includes one of a product, process, and service;
generate a forecast for the item based upon an assessment of the item during a life cycle; and
execute different scenarios relative to the assessment to compare forecasts for the item and different scenarios to the baseline forecast, wherein the baseline forecast and the forecasts for the item and different scenarios indicate carbon intensity, emissions, and carbon credits, and wherein the different scenarios are based upon changes to factors affecting the forecast for the item.

15. The computer program product of claim 14, wherein the factors include one or more from a group of material inputs, electricity mix, processes, equipment, and outputs.

16. The computer program product of claim 14, wherein the instructions further cause the at least one processor to:
periodically update the baseline forecast and the forecasts for the item and different scenarios at a configurable time interval.

17. The computer program product of claim 14, wherein the baseline forecast and the forecasts for the item and different scenarios encompass a configurable future time interval.

18. The computer program product of claim 14, wherein the instructions further cause the at least one processor to:
generate a visualization of the forecast for the item against actual values.

19. The computer program product of claim 18, wherein the visualization includes a graph and a data table for the forecast for the item and actual values.

20. The computer program product of claim 14, wherein the instructions further cause the at least one processor to:
update the baseline forecast and the forecasts for the item and different scenarios in real-time as data changes.
